(19) United States
(12) Patent Application Publication
(10) Pub. No.: US 2019/0057559 A1
(43) Pub. Date: Feb. 21, 2019

(54) METHODS FOR THE NON-VOLATILE STORING OF TRIGGER DATA FOR A VEHICLE AS WELL AS FOR A PARTICIPANT, A CORRESPONDING DEVICE, COMPUTER PROGRAM, AND A MACHINE-READABLE STORAGE MEDIUM

(71) Applicant: Robert Bosch GmbH, Stuttgart (DE)

(72) Inventors: Bastian Reckziegel, Kirchheim/Nabern (DE); Erich Sonntag, Marbach Am Neckar (DE); Gian Antonio D' Addetta, Stuttgart (DE); Johannes Ludwig Foltin, Ditzingen (DE); Sybille Eisele, Hessigheim (DE)

(21) Appl. No.: 15/999,179

(22) Filed: Aug. 16, 2018

(30) Foreign Application Priority Data
Aug. 17, 2017 (DE) 102017214316.9

(51) Int. Cl. G07C 5/08; G08G 1/00; B60R 21/01

(52) U.S. Cl. CPC G07C 5/085; B60R 21/01; G08G 1/205

(57) ABSTRACT

A method for the non-volatile storing of trigger data for a vehicle, including: detecting a trigger event; emitting a first trigger identification identifying the trigger event, and/or emitting a first participant identification identifying the vehicle; storing the first trigger data of the vehicle in a non-volatile manner, and a method for the non-volatile storing of trigger data for a participant, in particular of a further vehicle and/or a further infrastructure unit, including: receiving a first trigger identification and/or a first participant identification identifying a vehicle; and storing trigger data of the participant in a non-volatile manner.

### RELATED APPLICATION INFORMATION

The present application claims priority to and the benefit of German patent application no. 10 2017 214 316.9, which was filed in Germany on Aug. 17, 2017, the disclosure which is incorporated herein by reference.

### FIELD OF THE INVENTION

The present invention relates to a method for the non-volatile storing of trigger data for a vehicle as well as for a participant, to a corresponding device, computer program and a machine-readable storage medium.

### BACKGROUND INFORMATION

Current vehicles employ what is commonly known as accident memories or crash-data memories for the purpose of reconstructing the course of events of the accident if an accident has occurred and/or of checking the authorization for the triggering of restraint arrangement. A regulated minimum data quantity for the content of this data memory is provided, in particular for the US market, which is mostly implemented in the device for the actuation of the restraint arrangement (airbag control unit). These data are stored if a defined severity of the event is exceeded. This need not necessarily lead to the triggering of restraint arrangement in all cases.

Furthermore, the networking of road users is becoming more prevalent. In the future, not only will road users communicate with one another and exchange data but infrastructure units (such as traffic lights or digital traffic signs) will also contribute to this data transfer.

From the document DE 10 2012 211 568 A1, for instance, a method is discussed for determining crash-reaction data, the method lending itself to initiating at least one measure in response to an accident.

The method is able to be executed in conjunction with a vehicle that is equipped with a communications interface for the transmission of vehicle messages.

The method includes a step of reading in a vehicle message from the communications interface. In this instance, the vehicle message includes accident data pertaining to an accident of a vehicle involved in a crash.

In addition, the method includes a step of ascertaining the accident-reaction data with the aid of the crash data if an item of accident-location information of the crash data represents an accident location along a road section that the vehicle is to travel.

### SUMMARY OF THE INVENTION

Against this background, the present method is claimed for the non-volatile storing of trigger data for a vehicle. The present method includes the steps:
Detecting a trigger event;
Emitting a first trigger identification that identifies the trigger event and/or emitting a first participant identification that identifies the vehicle;
Storing first trigger data of the vehicle in a non-volatile manner.

In the present case, a trigger event is understood as an event that leads to a detection of sensor signals that exceed a predefined threshold. Such an event may, but need not necessarily, lead to the triggering of protective measures. Protective measures in this instance may mean the activation of passenger-protection arrangement, such as belt pretensioners, airbags and the like. In this particular context, the at least partially automatically activated brake and evasion systems may also be understood as protective measures.

A trigger identification is a unique character sequence or something similar, which is employed in order to identify the detected trigger event.

A participant identification is a unique character sequence or something similar, which is used for the identification of a participant. In this context, a participant may denote a vehicle, an infrastructure unit or, in general, another road user involved in the detected trigger event. According to the present invention, a participant is involved in a trigger event if the participant is able to obtain knowledge of the event. This is obvious in the case of directly involved participants such as other parties to the accident. Similarly involved is a road user whose sensor system is able to detect the trigger event or has detected the trigger event.

In this instance, trigger data are to be understood as data that have been generated in connection with the trigger event, or in other words, data that are able to be detected to a certain extent by the sensor systems of the participant prior to, during and following the trigger event. Time periods of 30 seconds prior to and 60 seconds following the trigger event have shown to be a relevant time period surrounding the trigger event. Depending on the available memory space or the bandwidth, this time period may be adapted accordingly.

In addition to the data of the classic crash-detection sensors (acceleration or pressure sensors), further data may also become part of the trigger data.

For example, the growing use of environmental sensor systems (e.g., video cameras, radar sensors, lidar sensors, ultrasonic sensors) allows for the storing also of the data from these systems (such as camera images) and for utilizing them as trigger data.

The additional utilization of data from environment-sensor systems not only makes it possible to store in a non-volatile manner the data that are independent of the trigger event, but the participants are simultaneously broadened so that they include participants that were not directly involved in the trigger event.

In the same way, data from the electronic stability control (e.g., the vehicle velocity, the gas-pedal position or a brake or steering intervention) may be counted among the trigger data.

In addition, location data, e.g., the positions based on GNNS or positions ascertained from other providers, may become part of the trigger data.

The data are able to be stored in a raw format or also in a (pre)processed format. For reasons of memory size, for instance, it may be necessary to limit the quantity.

In contrast to the current systems, which mostly allow for the evaluation of only the crash-detection sensors, the large variety of sensor data that are combined into trigger data according to the present invention makes it possible to draw more detailed inferences about the situation of the trigger event.

This allows for the holistic, non-volatile storing of data at the level of the trigger event, such as a crash.

In this instance, the non-volatile storing of the data is to be understood as the storing of the data in a way that secures the data on a permanent basis and in a manner that allows the data to be read out, at least by authorized parties. Authorized parties may be the owners of the data or state or private institutions such as police authorities, public prosecutors or insurance companies.

The non-volatile storage need not necessarily or exclusively take place in a memory that is physically installed in or on the vehicle.

The present aspect of the invention offers the advantage that an identification that is suitable for identifying the trigger event or the vehicle is emitted, so that during a subsequent evaluation of the trigger event access is possible to the trigger data of the vehicle stored in a non-volatile manner.

According to one specific embodiment, the present method includes an additional step of receiving and storing, in which at least one second trigger identification or at least one second participant identification (VEH-ID) and/or at least second trigger data from at least one further participant are received and stored.

Conceivable as a further participant in the sense of the present invention is, among others, a further vehicle and/or a further infrastructure unit.

This specific embodiment of the present invention offers the advantage that trigger data are stored in a non-volatile manner beyond the limits of individual vehicle systems or participant systems and/or that the trigger data are made accessible at least via the received identifications, thereby making it possible to synchronize or correlate it with one another.

Because identifications and/or trigger data of participants, i.e. both of other vehicles and from infrastructure units that are not directly involved in the trigger event, are received and stored/stored in a non-volatile manner, a more comprehensive picture of the trigger event is able to be created.

Another aspect of the present invention relates to a method for the non-volatile storing of trigger data for a participant, the method including the steps:
Receiving a first trigger identification and/or a first participant identification identifying a vehicle;
Storing trigger data of the participant in a non-volatile manner.

Conceivable as a participant in the sense of the present invention is a vehicle or an infrastructure unit, among others.

According to one specific embodiment, the present method includes the additional step of emitting a second trigger identification of the participant, i.e. the own trigger identification, or the trigger data of the participant, that is to say, the own trigger data.

In the present case, emitting may be understood as a process by which the participant makes the data to be emitted available to all recipients in the receiving range of the communications arrangement used.

This aspect of the present invention offers the advantage that it allows for a detailed analysis of the trigger event because of the non-volatile storing of trigger data across all of the participants. In addition, this allows for the non-volatile storing of trigger data of direct participants that would not have stored their own trigger data on their own because of the extent of the event, are stored in a non-volatile manner. For instance, this may happen when different event severities are encountered in trigger events that involve multiple participants. Since participants now store their own trigger data in a non-volatile manner in response to the receiving of a trigger and/or a participant identification, this aspect of the present invention then makes it possible that both the immediate participants and participants that are not directly involved store their trigger data in a non-volatile manner.

According to a specific embodiment of the present invention, the own trigger data are transmitted to the vehicle identified by the first participant identification in the step of emitting.

Because of the sharing of the own trigger data with the vehicle identified with the aid of the first participant identification, it is possible in this case to store these trigger data in the vehicle in a non-volatile manner in addition to the trigger data of the vehicle. Both the trigger data of the vehicle itself and that of participants are therefore available. This allows for easier access and an easier evaluation of the trigger data on the side of the vehicle.

According to specific embodiments of the method of the present invention, the trigger identifications include a time stamp in each case.

Adding time stamps to the trigger identifications assists in the allocation and the chronological classification of the trigger identifications and therefore helps in simplifying the evaluation of the trigger data available in the vehicles or in the participants.

According to specific embodiments of the methods of the present invention, the methods include the additional step of transmitting the trigger data, the trigger data being transmitted to a central server in the step of transmitting.

In this instance, a central server is to be understood as a server that is able to be reached via a communications network and is provided for the receiving of trigger data of a plurality of participants. Among others, communications networks such as the Internet, which are usable with the aid of wireless communications arrangement, e.g., radio, WLAN, GSM, LTE, and the like, are conceivable as communications network in this context.

The trigger data transmitted to the central server may therefore be jointly evaluated. If the transmitted trigger data include identifications in addition, then the trigger data may also be correlated with one another via the identifications so that a more comprehensive overall picture of the trigger situation may easily be formed, possibly automatically.

According to specific embodiments of the present method, the trigger data include a time stamp and/or velocity data and/or position data and/or movement directions and/or movement trajectories and/or a number and the status of the vehicle passengers in each case.

According to specific embodiments of the method of the present invention, the respective time stamps are generated on the basis of mutually synchronized clocks.

In the present case, synchronized clocks, among others, may be understood as coordinated clocks, which run according to the coordinated universal time (UTS), for instance. Also conceivable would be logical clocks, which are suitable for reconstructing a relative sequence of the detected (trigger) events.

The utilization of time stamps of synchronized clocks allows for a rapid and simple reconstruction of the time sequence of one and the same trigger event on the basis of the trigger data from a plurality of participants. For example, the course of events of a collision involving multiple parties is able to be determined in this way.

This may make it easier to settle the question of guilt. Furthermore, based on the evaluation of the trigger data, a potential for an improvement in the road safety may be worked out.

According to specific embodiments of the method of the present invention, the trigger data include the participant identification of the generating vehicle or participant.

Another aspect of the present invention pertains to a computer program, which is configured to carry out all of the steps of one of the specific embodiments of the method of the present invention.

A further aspect of the present invention relates to a machine-readable storage medium on which the computer program according to one of the aspects of the present invention is stored.

Another aspect of the present invention pertains to a device, which is configured to carry out all of the steps of one of the specific embodiments of the method of the present invention.

In the following text, specific embodiments of the present invention are illustrated and explained with the aid of figures.

### BRIEF DESCRIPTION OF THE DRAWINGS

FIG. 1 shows an illustration of an initial situation of an intersection scenario in which the present invention may be used.

FIG. 2 shows an illustration of a primary collision of an intersection scenario in which the present invention may be used.

FIG. 3 shows an illustration of a secondary collision of an intersection scenario in which the present invention may be used.

FIG. 4 shows a flow diagram of a method according to one aspect of the present invention.

FIG. 5 shows a flow diagram of a method according to a further aspect of the present invention.

### DETAILED DESCRIPTION

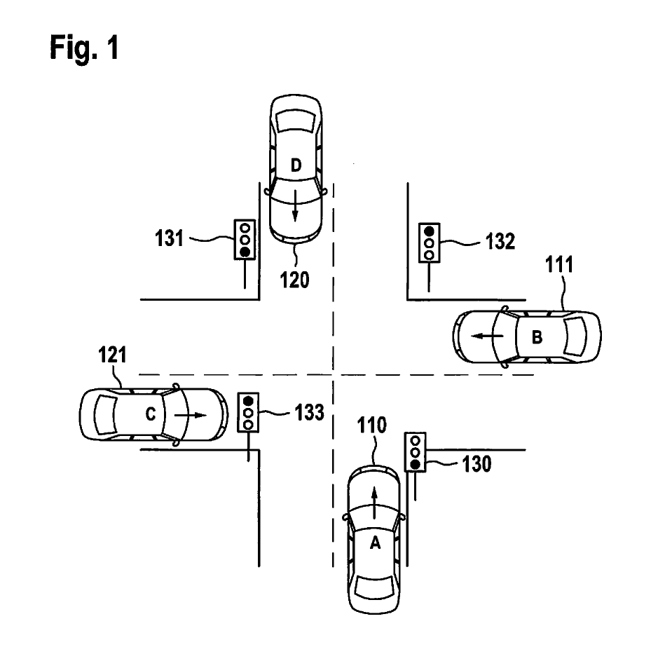

FIG. 1 shows an illustration of an initial situation of an intersection scenario in which the present invention may be used. In the illustrated situation, four vehicles 110, 111, 120, 121 arrive at an intersection, which is controlled with the aid of traffic lights 130, 131, 132, 133. Traffic lights 130, 131 for vehicles 110 and 120 show green and thus allow the vehicles to pass through. Traffic lights 132, 133 for vehicles 111 and 121 show read and thus require a stop.

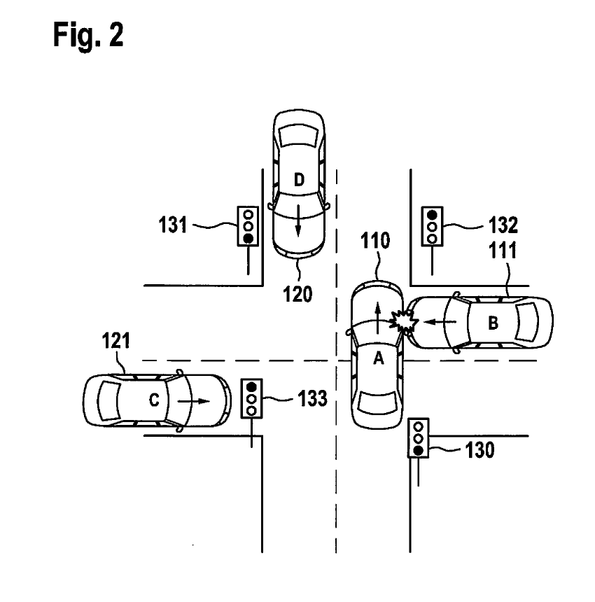

FIG. 2 shows an illustration of a primary collision of an intersection scenario in which the present invention may be used. The illustrated situation follows the initial situation introduced in FIG. 1. In this instance, vehicle 111 has ignored red traffic light 132. As a result, a first collision (primary collision) takes place with vehicle 110. According to the currently known systems, the collision data (trigger data) of vehicles 110 and 111 would be available in a situation such as this because their systems would have stored these data in a non-volatile manner due to the signals from their respective accident or crash-sensor systems.

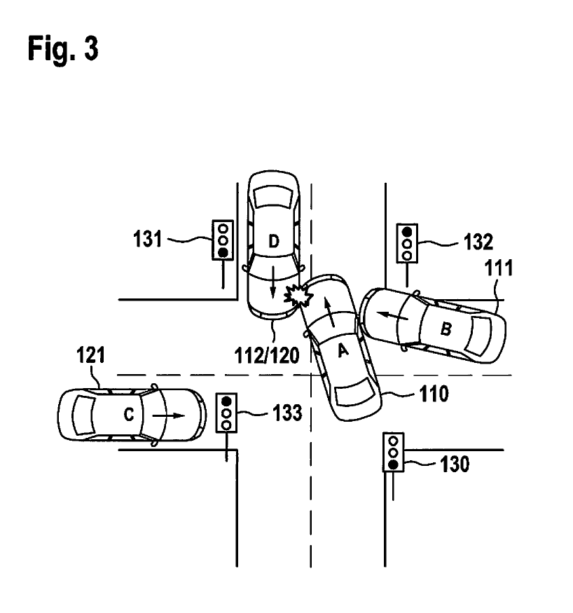

FIG. 3 shows an illustration of a secondary collision of an intersection scenario in which the present invention may be used. The illustrated situation follows the situation introduced in FIG. 2. In this instance, due to the mass inertia and the force of the collision, vehicle 110 is thrown into the oncoming traffic lane where it collides with vehicle 112/120 in a secondary collision. According to the currently known systems, the collision data (trigger data) of vehicles 110 and 112 would now be available in addition since their systems would have stored these data in a non-volatile manner because of the signals or the renewed signals from their respective accident or crash-sensor systems.

According to the present invention, an analysis of the accident situation would be improved by the following additional information.

The data of environment-sensor systems of not directly involved vehicles 120 and 121.

The data of the infrastructure units, i.e. of traffic lights 130, 131, 132,133, such as camera data of the intersection area, and the state of the traffic lights at the time of the collision, for example.

In addition to the own collision data (trigger data) of vehicles 110, 111, at least the participant identifications of the further, partially not directly involved participants (vehicles and infrastructure units) 120, 121, 130, 131, 132, 133, so that access to the memories of the participants is possible via the stored identifications for the purpose of evaluating the accident situation.

This is achieved by a method of the present invention according to which at least one trigger identification or vehicle identification is subsequently emitted in response to the detection of a trigger event such as a collision according to the illustrated situation.

According to the further aspect of the present invention, the participants store their trigger data in a non-volatile manner in response to the receiving of a trigger identification or a vehicle identification according to the present invention.

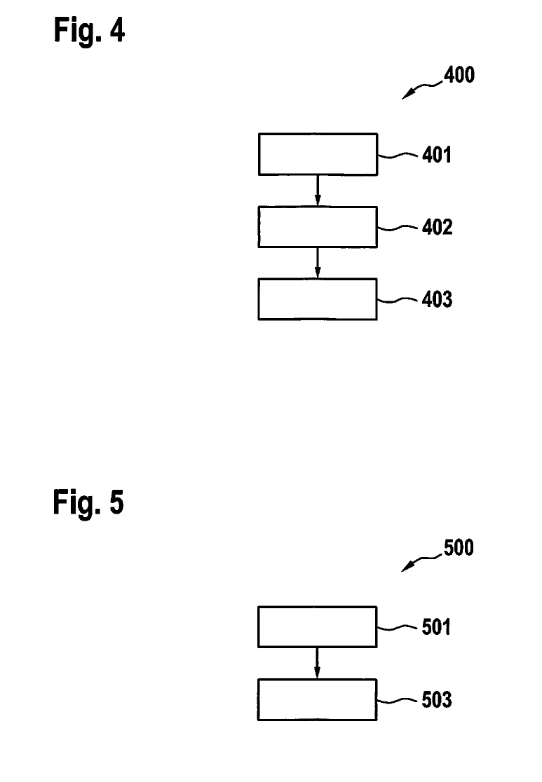

FIG. 4 shows a flow diagram of a method according to a first aspect of the present invention.

In step 401, a trigger event is detected. This may be realized with the aid of sensor systems of the vehicle, for instance when the accident or crash-sensor system responds because of a collision with the vehicle, and when the detected signals exceed corresponding threshold values, for example.

In step 402, a trigger identification that identifies the detected trigger event, and/or a participant identification that identifies the vehicle is/are emitted. The emitting may be accomplished with the aid of corresponding communications devices, such as by devices for a vehicle-to-vehicle (Car2Car) communication or a vehicle-to-environment (Car2x) communication.

In step 403, the non-volatile storing of the trigger data of the vehicle takes place. This may be accomplished in that the sensor systems available in the vehicle at least partially buffer-store their detected signals or the data derived therefrom for a predefined period of time. The buffer-storing may be realized with the aid of suitable ring-buffer structures, for instance.

During the non-volatile storing, the contents of the buffer storages are transferred into storage structures that allow for later access to these data. Conceivable for this purpose are storage structures like those already in use in what is known as event-data recorders (Black Box).

Step 403 need not necessarily take place after step 402. In principle, step 403 may also be carried out prior to or parallel with step 402.

FIG. 5 shows a flow diagram of a method according to a further aspect of the present invention.

In step 501, a trigger identification or a participant identification is received by a participant in the sense of the present invention.

In step 503, in response to the preceding receiving of a trigger identification or a participant identification, the trigger data of the participant are stored in a non-volatile manner. In principle, the non-volatile storing in a participant may be carried out in the manner illustrated with reference to the method according to a first aspect of the present invention in conjunction with a vehicle that is directly affected by the trigger event. That is to say, in that the sensor systems available on the side of the participant at least partially buffer-store their detected signals or the data derived therefrom for a predefined period of time. The buffer-storing may be accomplished with the aid of suitable ring buffer structures, for example. During the non-volatile storing, the contents of the buffer storages are transferred into non-volatile memory structures that allow for later access to these data. Conceivable for this purpose are storage structures like those already in use in what is known as event-data recorders (Black Box).

What is claimed is:

1. A method for providing non-volatile storing of trigger data for a vehicle, the method comprising:
detecting a trigger event;
emitting a first trigger identification identifying the trigger event, and/or emitting a first participant identification identifying the vehicle; and
storing the first trigger data of the vehicle in a non-volatile manner.

2. The method of claim 1, further comprising:
receiving and storing at least one second trigger identification and/or at least one second participant identification, and/or second trigger data of at least one further participant, including in particular a further vehicle and/or a further infrastructure unit.

3. A method for providing non-volatile storing of trigger data for a participant, including in particular a further vehicle and/or a further infrastructure unit, the method comprising:
receiving a first trigger identification and/or a first participant identification identifying a vehicle;
storing trigger data of the participant in a non-volatile manner.

4. The method of claim 3, further comprising:
emitting a second trigger identification of the participant and/or the trigger data of the participant.

5. The method of claim 4, wherein in the emitting, the trigger data of the participant are sent to the vehicle identified by the first participant identification.

6. The method of claim 1, further comprising:
sending the first and/or the second trigger data, the first and/or the second trigger data being sent to a central server in the step of sending.

7. The method of claim 1, wherein the trigger identifications include a time stamp in each case.

8. The method of claim 1, wherein the first and/or the second trigger data include a time stamp and/or velocity data and/or position data and/or movement directions and/or movement trajectories and/or the number of vehicle passengers in each case.

9. The method of claim 7, wherein the respective time stamps are generated based on mutually synchronized clocks, the synchronized clocks being coordinated clocks.

10. The method of claim 1, wherein the trigger data include the participant identification of the generating vehicle and/or the participant.

11. A non-transitory computer readable medium having a computer program, which is executable by a processor, comprising:
a program code arrangement having program code for providing non-volatile storing of trigger data for a vehicle, by performing the following:
detecting a trigger event;
emitting a first trigger identification identifying the trigger event, and/or emitting a first participant identification identifying the vehicle; and
storing the first trigger data of the vehicle in a non-volatile manner.

12. The computer readable medium of claim 11, further comprising:
receiving and storing at least one second trigger identification and/or at least one second participant identification, and/or second trigger data of at least one further participant, including in particular a further vehicle and/or a further infrastructure unit.

13. A device for providing non-volatile storing of trigger data for a vehicle, comprising:
a non-transitory computer readable medium having a computer program, which is executable by a processor, including:
a program code arrangement having program code for providing the non-volatile storing of the trigger data for the vehicle, by performing the following:
detecting a trigger event;
emitting a first trigger identification identifying the trigger event, and/or emitting a first participant identification identifying the vehicle; and
storing the first trigger data of the vehicle in a non-volatile manner.
